(19) United States
(12) Patent Application Publication
(10) Pub. No.: US 2015/0081699 A1
(43) Pub. Date: Mar. 19, 2015

(54) Apparatus, Method and Computer Program for Capturing Media Items

(71) Applicant: Nokia Corporation, Espoo (FI)

(72) Inventors: Jussi LEPPANEN, Tampere (FI); Antti ERONEN, Tampere (FI); Arto LEHTINIEMI, Lempaala (FI); Jukka HOLM, Tampere (FI)

(21) Appl. No.: 14/480,809

(22) Filed: Sep. 9, 2014

(30) Foreign Application Priority Data
Sep. 19, 2013 (GB) 1316629.3

(51) Int. Cl. G06F 17/30

(52) U.S. Cl. CPC G06F 17/30058
USPC 707/736

(57) ABSTRACT

An apparatus, method and computer program, the method comprising:
obtaining information associated with a plurality of media items wherein the plurality of media items are associated with a user of a media capturing apparatus and the information provides an indication of situations related to each of the plurality of media items; determining a situation associated with the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the media capturing apparatus.

### TECHNOLOGICAL FIELD

Embodiments of the present invention relate to an apparatus, method and computer program for capturing media items. In particular, they relate to an apparatus, method and computer program for capturing media items based on a detected situation associated with a user.

### BACKGROUND

Apparatus which enable a user to capture media items are known. The media items may comprise, for example, photographs, video or audio or other types of media item. For example communication devices such as cellular telephones may comprise an image capturing apparatus which may enable photographs and/or video items to be captured as well as means for enabling wireless communication. It may be useful to use the communication functionality of such devices to provide an improved media item capturing system for a user of such apparatus.

### BRIEF SUMMARY

According to various, but not necessarily all, examples of the disclosure there may be provided an apparatus comprising: processing circuitry; and memory circuitry including computer program code; the memory circuitry and the computer program code configured to, with the processing circuitry, cause the apparatus at least to perform: obtaining information associated with a plurality of media items wherein the plurality of media items are associated with a user of the apparatus and the information provides an indication of situations which relate to each of the plurality of media items; determining a situation associated with the user of the apparatus; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the apparatus.

In some examples the information may be obtained by analysing metadata associated with the plurality of media items wherein the metadata provides an indication of a situation which has been captured by the media items. The memory circuitry and the computer program code may be configured to, with the processing circuitry, cause the apparatus to perform analysis of the metadata.

In some examples the analysis of the metadata may be performed by a remote server and the apparatus is configured to receive the information obtained from the analysis.

In some examples the plurality of media items may comprise media items which have been captured by the user of the apparatus.

In some examples the plurality of media items may comprise media items which have been created by another user and which have metadata identifying the user of the apparatus associated with them.

In some examples the plurality of media items may comprise at least one of photographs, video, audio.

In some examples the situation of the user of the apparatus may comprise one or more of, people near the user, activities of people near the user, a location of the user, a time of day, a date, a type of weather, objects surrounding the user.

In some examples the media item suggestion may comprise an identification of people who could be included in the media item. The media item suggestion may comprise suggested positions for the people in a photograph.

In some examples the media item suggestion may comprise suggested objects to be included in the media item.

In some examples the predetermined threshold may comprise a time interval between capturing of media items associated with corresponding situations. In some examples the time interval may be of the order of a plurality of hours.

In some examples the time interval may comprise a plurality of weeks.

According to various, but not necessarily all, examples of the disclosure there may be provided a method comprising: obtaining information associated with a plurality of media items wherein the plurality of media items are associated with a user of a media capturing apparatus and the information provides an indication of situations related to each of the plurality of media items; determining a situation associated with the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the media capturing apparatus.

In some examples the information may be obtained by analysing metadata associated with the plurality of media items wherein the metadata provides an indication of a situation which has been captured by the media items. In some examples the analysis of the metadata may be performed by the user's media capturing apparatus.

In some examples the analysis of the metadata may be performed by a remote server and the information obtained from the analysis is provided to the user's media capturing apparatus.

In some examples the plurality of media items may comprise media items which have been captured by the user of the apparatus.

In some examples the plurality of media items may comprise media items which have been created by another user and which have metadata identifying the user of the media capturing apparatus associated with them.

In some examples the plurality of media items may comprise at least one of photographs, video, audio.

In some examples the situation associated with the user of the media capturing apparatus may comprise one or more of, people near the user, activities of people near the user, a location of the user, a time of day, a date, a type of weather, objects surrounding the user.

In some examples the media item suggestion may comprise an identification of people who could be included in the media item. In some examples the media item suggestion may comprise suggested positions for the people in a photograph.

In some examples the media item suggestion may comprise suggested objects to be included in the media item.

In some examples the predetermined threshold may comprise a time interval between capturing of media items associated with corresponding situations. In some examples the time interval may be of the order of a plurality of hours. In some examples the time interval may comprise a plurality of weeks.

According to various, but not necessarily all, examples of the disclosure there may be provided a computer program comprising computer program instructions that, when executed by processing circuitry, enable: obtaining information associated with a plurality of media items wherein the plurality of media items are associated with a user of a media capturing apparatus and the information provides an indication of situations related to each of the plurality of media items; determining a situation associated with the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the media capturing apparatus.

According to various, but not necessarily all, examples of the disclosure there may be provided a computer program comprising program instructions for causing a computer to perform the methods described above.

According to various, but not necessarily all, examples of the disclosure there may be provided a physical entity embodying the computer program as described above.

According to various, but not necessarily all, examples of the disclosure there may be provided an electromagnetic carrier signal carrying the computer program as described above.

According to various, but not necessarily all, examples of the disclosure there may be provided an apparatus comprising: processing circuitry; and memory circuitry including computer program code; the memory circuitry and the computer program code configured to, with the processing circuitry, cause the apparatus at least to perform: storing a plurality of media items wherein the plurality of media items are associated with a user of a media capturing apparatus; obtaining information associated with the plurality of media items wherein the information provides an indication of situations which are related to each of the plurality of media items; obtaining information indicating a situation of the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the threshold value; and enabling an indication of the media item suggestion to be provided to the user of the media capturing apparatus.

In some examples the information associated with the plurality of media items may be obtained by analysing metadata associated with the plurality of media items wherein the metadata provides an indication of a situation which has been captured by the media items.

In some examples the plurality of media items may comprise media items which have been captured by the user of the media capturing apparatus and uploaded to a remote server.

In some examples the plurality of media items may comprise media items which have been created by another user and which have metadata identifying the user of the media capturing apparatus associated with them.

According to various, but not necessarily all, examples of the disclosure there may be provided a method comprising: storing a plurality of media items wherein the plurality of media items are associated with a user of an media capturing apparatus; obtaining information associated with the plurality of media items wherein the information provides an indication of situations which are related to each of the plurality of media items; obtaining information indicating a situation of the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the threshold value; and enabling an indication of the media item suggestion to be provided to the user of the media capturing apparatus.

In some examples the information associated with the plurality of media items may be obtained by analysing metadata associated with the plurality of media items wherein the metadata provides an indication of a situation which has been captured by the media items.

In some examples the plurality of media items may comprise media items which have been captured by the user of the media capturing apparatus and uploaded to a remote server.

In some examples the plurality of media items may comprise media items which have been created by another user and which have metadata identifying the user of the image capturing apparatus associated with them.

According to various, but not necessarily all, examples of the disclosure there may be provided a computer program comprising computer program instructions that, when executed by processing circuitry, enable: storing a plurality of media items wherein the plurality of media items are associated with a user of a media capturing apparatus; obtaining information associated with the plurality of media items wherein the information provides an indication of situations which are related to each of the plurality of media items; obtaining information indicating a situation of the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the threshold value; and enabling an indication of the media item suggestion to be provided to the user of the media capturing apparatus.

According to various, but not necessarily all, examples of the disclosure there may be provided a computer program comprising program instructions for causing a computer to perform the methods described above.

According to various, but not necessarily all, examples of the disclosure there may be provided a physical entity embodying the computer program as described above.

According to various, but not necessarily all, examples of the disclosure there may be provided an electromagnetic carrier signal carrying the computer program as described above.

The apparatus may be for capturing media items. The media items may comprise at least one of photographs, video, audio. The apparatus may also be configured to enable wireless communication.

### BRIEF DESCRIPTION

For a better understanding of various examples that are useful for understanding the brief description, reference will now be made by way of example only to the accompanying drawings in which:

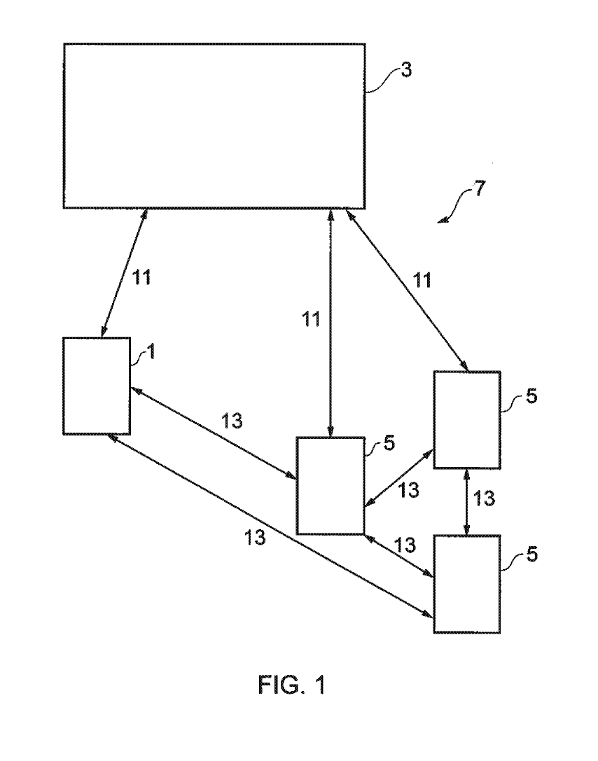

FIG. 1 illustrates a system;

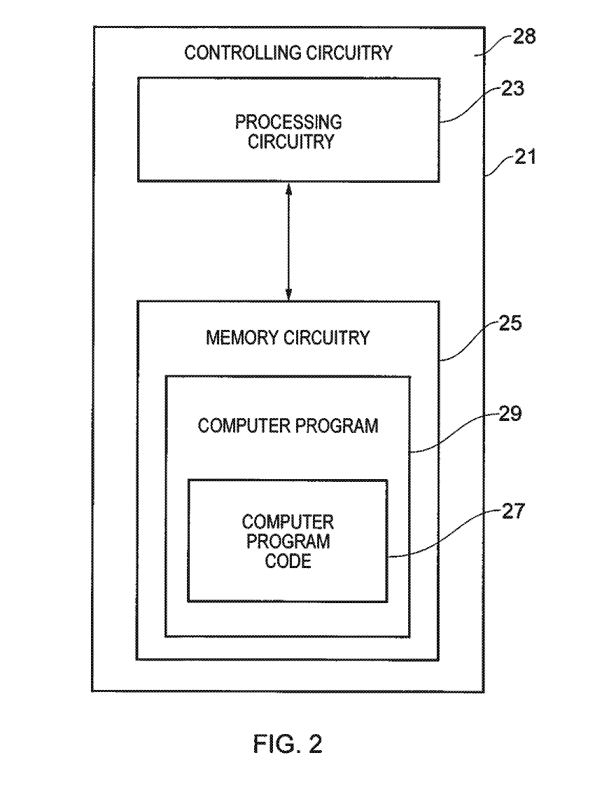

FIG. 2 illustrates an apparatus;

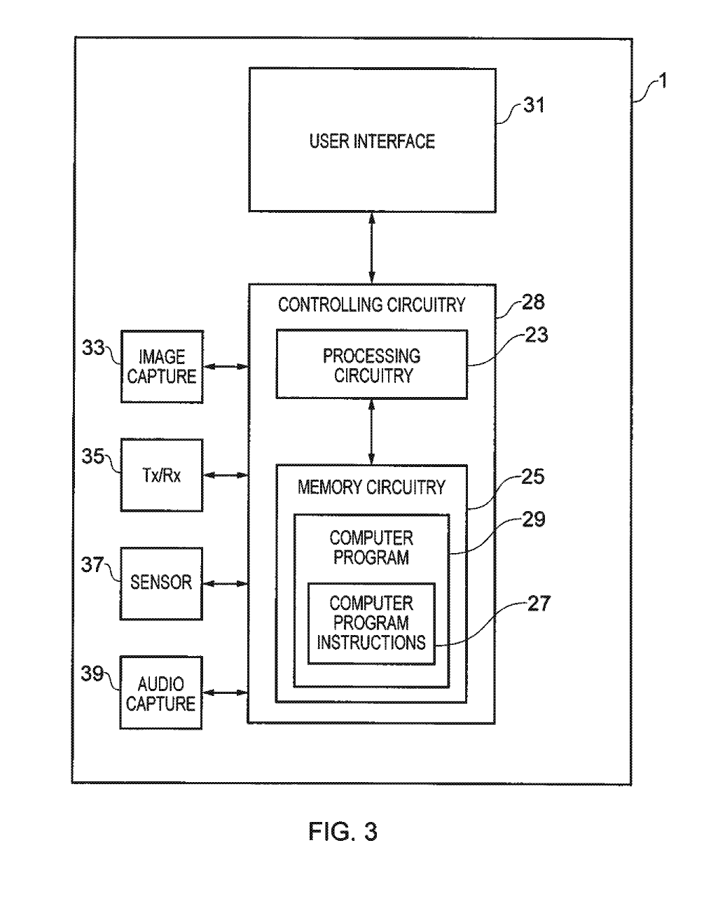

FIG. 3 illustrates an apparatus;

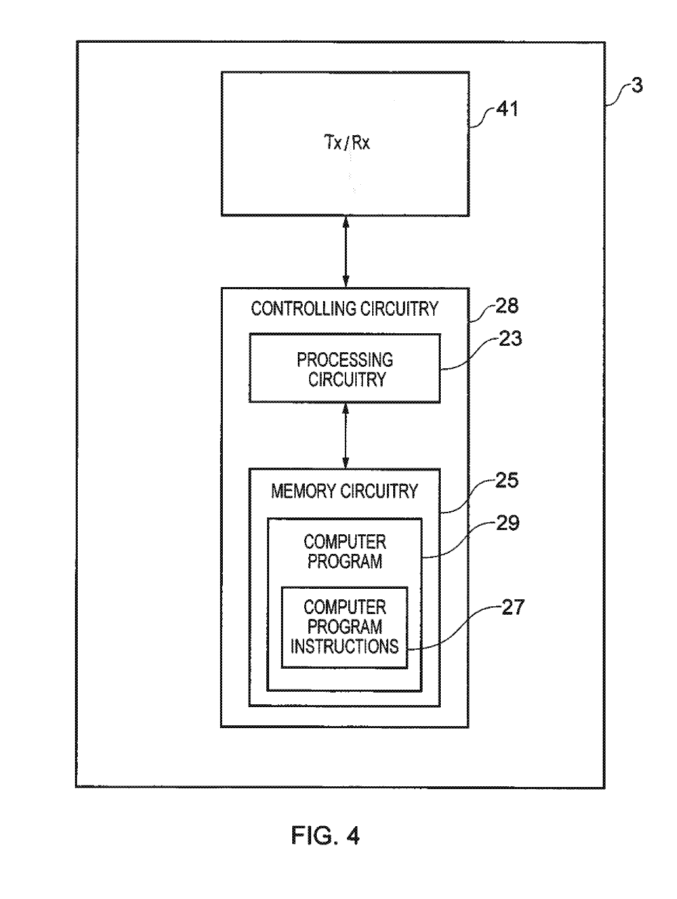

FIG. 4 illustrates an apparatus;

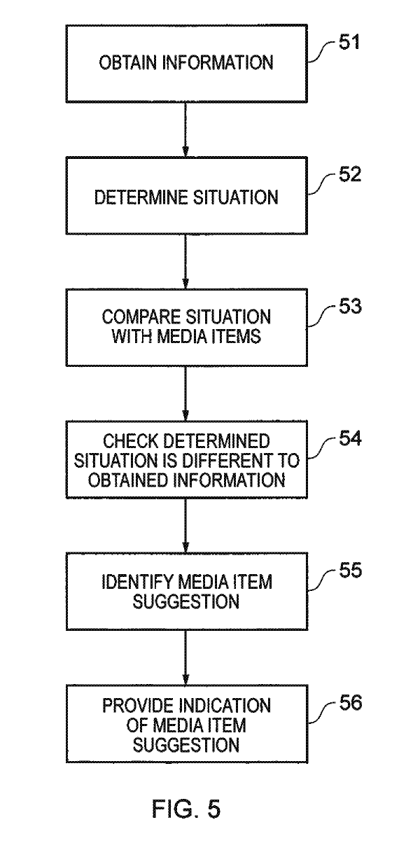

FIG. 5 illustrates a method; and

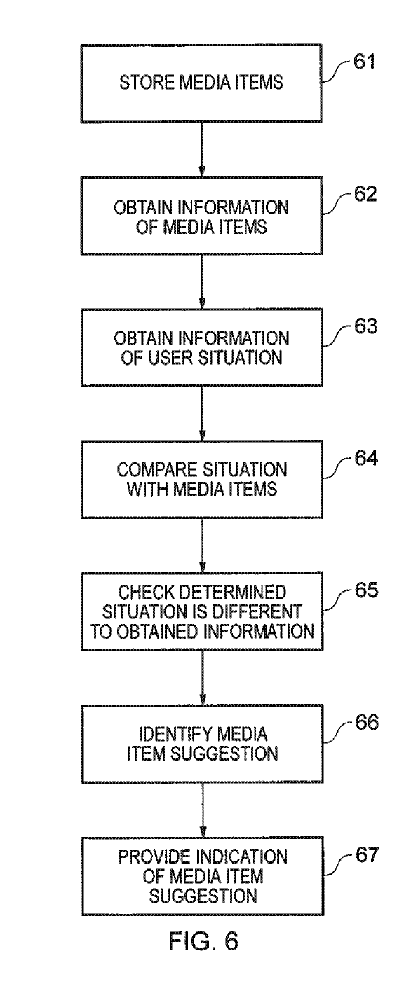

FIG. 6 illustrates a method.

### DETAILED DESCRIPTION

The Figures illustrate an apparatus 1 comprising: processing circuitry; and memory circuitry including computer program code; the memory circuitry and the computer program code configured to, with the processing circuitry, cause the apparatus 1 at least to perform: obtaining information associated with a plurality of media items wherein the plurality of media items are associated with a user of the apparatus 1 and the information provides an indication of situations related to each of the plurality of media items; determining a situation associated with the user of the apparatus 1; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the apparatus 1.

The Figures also illustrate an apparatus comprising: processing circuitry; and memory circuitry including computer program code; the memory circuitry and the computer program code configured to, with the processing circuitry, cause the apparatus at least to perform: storing a plurality of media items wherein the plurality of media items are associated with a user of a media capturing apparatus 1; obtaining information associated with the plurality of media items wherein the information provides an indication of situations which are related to each of the plurality of media items; obtaining information indicating a situation of the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the threshold value; and enabling an indication of the media item suggestion to be provided to the user of the media capturing apparatus 1.

FIG. 1 illustrates an example system 7 according to examples of the disclosure. The example system 7 comprises a user apparatus 1 and one or more servers 3. The system 7 may also comprise one or more other user apparatus 5. A plurality of communication links 11, 13 are provided between the apparatus 1, 5 and the one or more servers 3.

The user apparatus 1, 5 may comprise an apparatus as illustrated in FIGS. 2 and 3 and described below. The apparatus 1 may be configured to enable a user of the apparatus 1 to capture media items. For example, the user apparatus 1 may comprise an image and/or video capture apparatus which may enable a user to take photographs and/or video. In some examples the user apparatus 1 may comprise an audio capture apparatus which may enable the user to capture audio. In some examples the user apparatus 1, 5 may also be configured to enable wireless communication.

The one or more servers 3 may comprise an apparatus as illustrated in FIG. 4. The one or more servers 3 may comprise any apparatus which provides services which may be used to facilitate the capturing of media items by the user's apparatus 1.

In some examples the servers 3 may comprise storage facilities which may enable a plurality of media items associated with a user to be stored and accessed by the users of the user apparatus 1, 5.

In some examples the one or more servers 3 may comprise processing facilities which may be configured to carry out processing tasks such as the analysis of information. The outcome of the processing tasks may be provided to the user apparatus 3, 5.

The system 7 may be arranged so that the user apparatus 1, 5 are located close to each other. In some examples the user apparatus 1, 5 may be within a few metres of each other. In some examples the user apparatus 1, 5 may be in the same room. In some examples the user apparatus, 1, 5 may be located close enough to each other to enable short range communication between the user apparatus 1, 5.

A plurality of communication links 13 may be provided between the user apparatus 1, 5. The communication links 13 may enable the user apparatus 1, 5 to communicate directly with each other. The communication links may enable the user apparatus 1, 5 to communicate without any intervening components. This may enable ad hoc or spontaneous networks to be created whenever a plurality of user apparatus 1, 5 are located close to each other.

The communication links 13 may comprise any means which enables information to be transferred between the user apparatus 3, 5. The communication links 13 may comprise any suitable short range and/or low power communication links such as Bluetooth, infra red, near field communication (NFC), wireless local area network (WLAN) or any other suitable communication link.

The system may be arranged so that the one or more servers 3 are located remotely from the user apparatus 1, 5. For example the one or more servers 3 need not be located in the same room as the user apparatus 1, 5 but could be located a large distance away from the user apparatus 1, 5.

In the example system 7 of FIG. 1 a plurality of communication links 11 are provided between the user apparatus 1, 5 and the one or more servers 3. The communication links 11 may comprise any means which enables information to be transferred between the user apparatus 1, 5 and the one or more servers 3. In some examples each of the user apparatus 1, 5 may be configured to communicate with the one or more servers 3. In other examples only some of the user apparatus 1, 5 may be configured to communicate with the one or more servers 3. It is to be appreciated that in such examples the user apparatus 5 which are not configured to communicate with the one or more servers 3 may still communicate with the other user apparatus 1, 5.

The communication links 11 between the one or more servers 3 and the user apparatus 1, 5 may comprise wireless network cellular communication links such as a cellular communications network or a wireless connect to the internet or any other suitable connection. The communication links 11 may enable long range communication.

The system 7 may be transient so that the user apparatus 1, 5 which form part of the system is not fixed. The user apparatus 1, 5 may be mobile devices which the users may carry with them. The systems 7 may change as people and their user apparatus 1, 5 arrive and/or leave the location of the system.

In the example of FIG. 1 only one server 3 and three other user apparatus 5 have been illustrated. It is to be appreciated that in other examples the system 7 may comprise different numbers of servers 3 and other apparatus 5.

The system 7 may enable methods such as the methods of FIGS. 5 to 6 to be implemented.

FIG. 2 illustrates an apparatus 21. The apparatus 21 illustrated in FIG. 2 may be a chip or a chip-set.

The apparatus 21 may comprise controlling circuitry 28. The controlling circuitry 28 may comprise one or more controllers. The controlling circuitry 28 may be implemented using instructions that enable hardware functionality, for example, by using executable computer program instructions in a general-purpose or special-purpose processing circuitry 23 that may be stored on a computer readable storage medium (disk, memory etc) to be executed by such processing circuitry 23.

The processing circuitry 23 may be configured to read from and write to the memory circuitry 25. The processing circuitry 23 may comprise one or more processors. The processing circuitry 23 may also comprise an output interface via which data and/or commands are output by the processing circuitry 23 and an input interface via which data and/or commands are input to the processing circuitry 23.

The memory circuitry 25 may be configured to store a computer program 29 comprising computer program instructions (computer program code 27) that controls the operation of the apparatus 21 when loaded into processing circuitry 23. The computer program instructions, of the computer program 29, provide the logic and routines that enables the apparatus 21 to perform methods such as those illustrated in FIGS. 5 to 6. The processing circuitry 23 by reading the memory circuitry 25 is able to load and execute the computer program 29.

The apparatus 21 therefore comprises: processing circuitry 23; and memory circuitry 25 including computer program code 27; the memory circuitry 25 and the computer program code 27 configured to, with the processing circuitry 23, cause the apparatus 21 at least to perform: obtaining information associated with a plurality of media items wherein the plurality of media items are associated with a user of a media capturing apparatus and the information provides an indication of situations related to each of the plurality of media items; determining a situation associated with the user of the media capturing apparatus; comparing the determined situation with the situations indicated by the obtained information; checking whether the determined situation differs from the situation indicated by the obtained information by at least a predetermined threshold value; identifying a media item suggestion if the determined situation exceeds the predetermined threshold value; and providing an indication of the media item suggestion to the user of the media capturing apparatus.

The computer program may arrive at the apparatus via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program. The delivery mechanism may be a signal configured to reliably transfer the computer program. The apparatus may propagate or transmit the computer program as a computer data signal.

Although the memory circuitry is illustrated as a single component it may be implemented as one or more separate components some or all of which may be integrated/removable and/or may provide permanent/semi-permanent/dynamic/cached storage.

Although the processing circuitry is illustrated as a single component it may be implemented as one or more separate components some or all of which may be integrated/removable.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

FIG. 3 schematically illustrates a user apparatus 1 comprising a controlling circuitry 28 as illustrated in FIG. 2 and described above. The user apparatus 1 could be any of the user apparatus 1, 5 of the system of FIG. 1. In the example of FIG. 3 the user apparatus 1 also comprises a user interface 31, an image capturing apparatus 33 and at least one transmitter/receiver 35. In some examples the user apparatus 1 may also comprise one or more sensors 37. In some examples the user apparatus 1 may also comprise audio capture apparatus 39.

The user apparatus 1 may be an electronic apparatus which is configured to enable media items to be captured. The user apparatus 1 may be, for example, a camera, a video camera, a mobile cellular telephone, a personal computer or any other apparatus which may be configured to enable media items to be captured. The user apparatus 1 may be a portable apparatus 1 which can be carried by the user, for example, in a user's hand, handbag or pocket of their clothing.

Only features referred to in the following description are illustrated in FIG. 3. However, it should be understood that the user apparatus 1 may comprise additional features that are not illustrated.

The controlling circuitry 28 may be configured to control the user apparatus 1. The controlling circuitry 28 may be configured to control the components of the apparatus 1 such as the user interface 31, the image capturing apparatus 33, the audio capturing apparatus 39, the transmitter/receiver 35 and the one or more sensors 37.

The controlling circuitry 28 may be configured to control the user apparatus 1 to perform a plurality of different functions. For example, where the user apparatus 1 is configured for wireless communications the controlling circuitry 28 may be configured to control the user apparatus 1 to perform functions such as sending and receiving information or accessing the one or more servers 3.

The user interface 31 may comprise any means which enables a user to control the user apparatus 1. The user interface 31 may comprise a user input means which may enable a user to input information into the apparatus 1. The user interface 31 may also comprise a user output means such as a display which may enable information to be provided to the user. The user interface 31 may comprise, for example a display, touch sensitive display, a plurality of buttons, a keypad, motion sensors or any other suitable type of user interface.

The image capturing apparatus 33 may comprise any means which may enable images such as photographs and/or video images to be captured. In some examples the image capturing apparatus 33 may comprise an optical arrangement and an image sensor. In some examples the image capturing apparatus 33 may also comprise one or more drives.

The image sensor may comprise any means which is configured to convert light incident on the image sensor into an electrical signal to enable an image such as a photograph to be produced. The image sensor may comprise, for example, a digital image sensor such as a charge-coupled-device (CCD) or a complementary metal-oxide-semiconductor (CMOS). The processing circuitry 23 may be configured to receive inputs from the image sensor. For example, the processing circuitry 23 may be configured to retrieve an electrical signal comprising image data from the image sensor and store it in the memory circuitry 25. In some examples, the processing circuitry 23 may be configured to send the image data to the one or more servers 3 to enable the image data to be stored at the one or more servers 3. The image data may be in the form of a photograph and/or video.

The optical arrangement may comprise any means configured to focus or deflect incident light from an object onto the image sensor. The optical arrangement may receive the incident light from an object or scene external to the user apparatus 1 through an aperture in a housing of the user apparatus 1. The optical arrangement may comprise, for example, one or more optical devices such as one or more lenses.

In some examples the image capture apparatus 33 may also comprise one or more drives. The one or more drives may comprise any means which enables movement of at least part of the optical arrangement relative to the image sensor. For example, the one or more drives may comprise an electric motor or an electromechanical solenoid.

The user apparatus 1 may also comprise an audio capture apparatus 39. The audio capture apparatus 39 may comprise any means which may enable audio media items to be captured. In some examples the audio capture apparatus 39 may enable audio inputs to be combined with captured images such as photographs or video.

In some examples the audio capture apparatus 39 may comprise a microphone or any other means for detecting an acoustic sound wave and connecting the detected acoustic sound wave into an electrical signal. The audio capture apparatus 39 may also comprise means for filtering or otherwise modifying the obtained audio input.

The user apparatus 1 illustrated in FIG. 3 also comprises a transmitter/receiver 35. The transmitter/receiver 35 may comprise any means that enables the user apparatus 1 to send data to and receive data from another user apparatus 5 or from the one or more servers 3. The transmitter/receiver 35 may be configured to enable wireless communication. For example the transmitter/receiver 35 may be configured to enable the user apparatus 1 to operate in a cellular communications network.

In the example illustrated in FIG. 3 the transmitter/receiver 35 has been illustrated as a single entity. It is to be appreciated that the transmitter/receiver 35 may comprise a separate transmitter and receiver. It is also to be appreciated that more than one transmitter and more than one receiver may be provided within a single apparatus 1.

In the example of FIG. 3 the user apparatus 1 also comprises one or more sensors 37. The one or more sensors 37 may comprise any means which may be configured to detect one or more conditions of the current environment of the user of the apparatus 1 and provide an output to the controlling circuitry 28 indicative of the detected condition. For example, the sensors 37 may be configured to detect the location of the user, the current light levels around the user, audio signals around the user, the temperature of the use's location, movement of the user or any other suitable parameter.

In some examples the sensors 37 may comprise a plurality of different physical sensors, which may comprise an accelerometer, gyroscope, Global Positioning System (GPS) receiver, ambient light sensor, microphone, temperature sensor, and any other suitable sensors. In some examples, the sensors may comprise algorithms which analyse the data provided by the physical sensors and provide inferences regarding the situation. An example is an algorithm which receives the accelerometer signal data, analyses the patterns in the accelerometer signal data, and compares these patterns to typical, pretrained movement patterns of persons performing different physical activities such as running, walking, or being still. Based on the comparison, the algorithm may decide the user's physical activity, such as walking, running, or being still. Such algorithm may be based on, for example, analysing the magnitude of the accelerometer signal data to determine features such as the magnitude spectrogram, and then comparing the features to features extracted from accelerometer signals from devices carried by people performing different activities. The comparison may be done based on pattern classification method, using, for example, support vector machines, neural networks, Gaussian mixture models, tree-based classifiers, and so on.

As another example, there might be provided an algorithm which analyses the audio data captured by the audio capture apparatus 39 to determine the sound level. In such examples there may be an audio-based environment classifier which analyses features from the audio signal captured by the audio capture apparatus 39 and compares these to features extracted from audio signals which have been recorded in different environments during a training stage. Typical environments might include a street, restaurant, or a pub. For example, mel-frequency cepstral coefficient features might be used, and the distribution of features for each class might be modelled with Gaussian mixture models.

In some examples the one or more sensors 37 may be configured to access a server 3 to obtain information which may be used to detect a condition of the current environment of the user. For example, the sensor 37 may comprise a GPS receiver which may be configured to provide location data to a server 3.

The server 3, may then consult a database such as a map database to determine the situation, such as a restaurant at that location. In some embodiments, the situation information may be provided from the server 3 to the user apparatus 1.

The example user apparatus 1 of FIG. 3 may be used to implement methods such as those illustrated in FIGS. 5 to 6 and described below.

FIG. 4 schematically illustrates a server 3 which may comprise part of the network 7. The server 3 may also comprise a controlling circuitry 28 as illustrated in FIG. 2 and described above.

Only features referred to in the following description are illustrated in FIG. 4. However, it should be understood that the user apparatus 1 may comprise additional features that are not illustrated.

The controlling circuitry 28 may be configured to control the server 3. For example the controlling circuitry 28 may be configured to enable the server 3 to store information such as a plurality of media items associated with a user and enable the plurality of media items to be accessed by the users of the user apparatus 1, 5. The controlling circuitry 28 may also be configured to enable the server 3 to carry out processing tasks such as the analysis of information and provide information indicative of the outcome of the processing tasks to be provided to the user apparatus 1, 5.

The server 3 therefore comprises: processing circuitry 23; and memory circuitry 25 including computer program code 27; the memory circuitry 25 and the computer program code 27 configured to, with the processing circuitry 23, cause the server 3 at least to perform: storing a plurality of media items wherein the plurality of media items are associated with a user of a media capturing apparatus 1; obtaining information associated with the plurality of media items wherein the information provides an indication of situations which are related to each of the plurality of media items; obtaining information indicating a situation of the user of the media capturing apparatus 1; comparing the determined situation with the situations indicated by the obtained information; checking whether the determined situation differs from the situation indicated by the obtained information by at least a predetermined threshold value; identifying a media item suggestion if the determined situation exceeds the threshold value; and enabling an indication of the media item suggestion to be provided to the user of the image capturing apparatus 1.

The server 3 illustrated in FIG. 4 also comprises a transmitter/receiver 41. The transmitter/receiver 41 may comprise any means that enables the server 3 to send to and receive data from other apparatus in the system 7. For example the server 3 may be configured to send data to and receive data from the user apparatus 1, 5 and from other servers 3.

In some examples the transmitter/receiver 41 may be configured to enable wireless communication. For example the transmitter/receiver 41 may be configured to enable the servers 3 to operate in a cellular communications network.

In the example illustrated in FIG. 4 the transmitter/receiver 41 has been illustrated as a single entity. It is to be appreciated that the transmitter/receiver 35 may comprise a separate transmitter and receiver. It is also to be appreciated that more than one transmitter and more than one receiver may be provided within a single server 3.

FIGS. 5 to 6 are block diagrams which schematically illustrate example methods. The example methods may be implemented using the apparatus 1 and systems 7 described above.

The example method of FIG. 5 may be implemented using a user apparatus 1.

The method comprises, at block 51, obtaining information associated with a plurality of media items. The plurality of media items may be associated with the user of the apparatus 1. The information which is obtained may provide an indication of situations which are related to each of the plurality of media items.

The plurality of media items may comprise media items which have been captured by the user of the apparatus 1. The media items may comprise photographs and/or video which has been captured using the image capturing apparatus 33 of the user apparatus 1 and/or any other suitable device. The media items may comprise audio items which have been captured using the audio capture apparatus 39. In some examples the plurality of media items may comprise media items which have been taken by other users using other devices. In such examples the media items may be associated with the user by identifying the user in the media item or by any other suitable means.

The plurality of media items may comprise media items which have been taken in the recent past. The plurality of media items may also comprise media items which have been captured earlier. For example the plurality of media items could comprise media items which have been captured and/or uploaded over a plurality of years.

The information may be obtained by analysing metadata associated with the plurality of media items. The metadata associated with a media item such as a photograph or video may provide an indication of a situation which has been photographed or videoed. The metadata associated with an audio recording may provide an indication of the situation which has been recorded.

In some examples the analysis of the metadata may be carried out by the user apparatus 1. In such examples the plurality of media items and/or information associated with the media items may be stored in the memory circuitry 25 of the user apparatus 1. In other examples the analysis of the metadata may be carried out by another apparatus such as the one or more servers 3 or the other user apparatus 5 in the system 7. In such examples the information may be obtained from the another apparatus via the communication links 11, 13.

The metadata associated with the plurality of media items may comprise any information which provides an indication of the situation which has been captured by the media item. In some examples the metadata may also comprise information which gives an indication of other parameters of the photograph such as the quality or the age of the media item or any other suitable parameter.

In some examples the metadata may comprise information which is created by the user apparatus 1 when the media item is captured. The metadata may be created automatically without any additional user input. The automatically created metadata may comprise information such as the arrangement of the image capturing apparatus 33 when a photograph or video was captured. It may contain information such as the focal length of the image capturing apparatus 33 and the configuration of the optical arrangement when the photograph was taken or any other suitable information. In some examples the metadata may comprise the arrangement of an audio capture apparatus 39 when an audio recording was captured. For example, it may indicate which filters have been applied to the detected acoustic signals.

In some examples the metadata may comprise information which indicates when the media item was captured. Such information may comprise the date and/or the time of day or any other suitable information.

The metadata may comprise information which is added by users of apparatus 1, 5. The users may be the user of the user apparatus 1 and/or users of another apparatus 5. The user who has added the metadata to a media item need not be part of the system 7 as illustrated in FIG. 1. They may be a user who is able to access the plurality of media items through a different apparatus or device.

The metadata added by the user may comprise information indicating the time and/or location and/or occasion that the media item was captured. The metadata may comprise information identifying people and/or objects in the media item. The metadata may comprise information indicating the quality of the media item or whether or not the users like the media item or any other suitable information.

In some examples the metadata may comprise information which is obtained from software based analysis of the media item. For example the processing circuitry 23 may be configured to analyse the pixels within a media item such as a photograph. The analysis may obtain information about the quality of the image or enable identification of objects or people within the image. The analysis may comprise any combination of image analysis methods, such as image segmentation, object detection, object recognition, visual feature extraction, and visual feature matching. For example, recognition of objects might be done by segmenting candidate object regions from the image, extracting one or more visual features which describe the segmented objects, and then comparing these visual features against visual features representing a set of known objects. A typical example might include detection and recognition of faces in an image.

In some examples the metadata may comprise information which is obtained by sensors 37 within the apparatus 1. The metadata obtained by the one or more sensors 37 may be obtained automatically or it may be obtained in response to a user input.

The one or more sensors 37 may detect conditions of the environment of the user apparatus 1 when the media item is captured. For example the one or more sensors 37 may detect the light levels or the type of weather or the people who are in proximity to the user or any other suitable information. Such information may be associated with the media item automatically when the media item is taken without any additional user input required by the user.

The metadata may be used to associate the media items with the user of the apparatus 1. For example the metadata may indicate that the media item was taken with the user's apparatus or that the user is in the media item.

The situations included in the plurality of media items may comprise the people or the groups of people that are in the media item. In some examples the situations may comprise the relative positions of people and/or objects which are in a media item such as a photograph. In some examples the situation may comprise information relating to the weather or the light levels or the quality of the photograph. The situation may also comprise information such as the time of day or the date that the media item was taken. It is to be appreciated that the situation may comprise any parameter which may be of interest to a user of an apparatus 1 who wishes to capture media items.

The obtaining of information associated with a plurality of media items may happen continuously. For example, in some embodiments, the apparatus 1 may detect whenever a media item is captured or uploaded and may be configured to analyse any metadata associated with the media item. In other examples the obtaining of information may happen periodically at predefined time intervals. The length of the time intervals may be set by the user of the apparatus 1.

At block 52 the method comprises determining a situation associated with the user of the apparatus 1. The situation of the user of the apparatus 1 may comprise the current conditions of the environment of the user. In some examples the situation may comprise the people or the groups of people that are located near the user. In some examples the situation may comprise the actions and/or activities of one or more people that are located near the user.

The user apparatus 1 may be configured to determine the people located near the user by identifying other user apparatus 5 which are currently in proximity to the user apparatus 1. This apparatus may be configured to use short range communications or any other suitable technique to detect and identify other user apparatus 5.

In other examples the apparatus 1 may be configured to sense and recognise the people and/or other objects around the user. For instance the apparatus 1 may configured to use image recognition to recognise people and/or objects which are near the user of the apparatus 1. In such examples the user may be able to use the image capturing apparatus 33 to scan their surroundings without capturing an image. The processing circuitry 23 may be configured to recognise certain objects or people. In some examples the processing circuitry 23 of the user apparatus 1 may use a stored plurality of photographs to enable identification of the people and/or objects around the user. This may be advantageous if the user is nearby people or objects who do not have a communications device, for example a baby or young child or a pet.

In some examples the one or more sensors 37 of the apparatus 1 may comprise a microphone which may be configured to detect noises around the user. The detected noises may then be used to identify the people or objects around the user. This technique of identifying nearby users may be advantageous as the user does not need to direct the user apparatus 1 towards the origin of the noise in order for the noise to be detected.

In some examples the current situation of the user of the apparatus 1 may comprise other parameters such as the location of the user or objects which are currently located closed to the user. In some examples the situation may comprise information relating to the environment of the user such as the current weather or the light levels or the noise levels. The situation may also comprise information such as the time of day or the current date.

Information stored in the memory circuitry 25 of the user apparatus 1 may be used to enable the current situation of the user of the apparatus 1 to be determined. For example, the user may have stored calendar information or diary information which indicates where they are likely to be at a particular time in the memory circuitry 25.

In some examples information which is input by the user using the user interface may be used to enable the current situation of the user of the apparatus 1 to be determined. In some examples the user may be able to select an option from a menu to make an indication of their location or the occasion or other information indicative of their current situation.

The determining of the current situation of the user of the apparatus 1 may happen continuously. For example the one or more sensors 37, the image capture apparatus 33 and the audio capture apparatus 39 may be configured to continuously obtain information which may be used to determine the current situation of the user of the apparatus 1. In other examples the determining of the current situation may happen periodically or in response to predefined trigger events. For instance, the sensors 37, the image capture apparatus 33 and the audio capture apparatus 39 may be activated at predefined time intervals. The length of the time interval may be determined by the user of the apparatus 1.

In some examples information relating to the current situation of the user of the apparatus 1 may be shared between the user apparatus 1, 5 in the system. For example, in some systems only one of the user apparatus 1, 5 may be configured for image recognition. In such examples this apparatus may use image recognition to identify users near the apparatus 1. This information may then be shared with the other user apparatus 1, 5 which do not have image recognition capability.

Information identifying the determined situation may be provided to the processing circuitry 23 of the user apparatus 1.

At block 53 the method comprises comparing the determined current situation associated with the user of the apparatus 1 with the situations associated with the plurality of media items which are indicated by the obtained information. In some examples the comparison may be made by the processing circuitry 23 of the user apparatus 1. In other examples the information identifying the determined situation may be provided to one or more servers 3 to enable the server to carry out the comparison.

At block 54 the method comprises checking whether the determined situation differs from the situation indicated by the obtained information by at least a predetermined threshold value. The comparison may be used to check whether or not the user has a media item corresponding to a situation which is the same as or similar to the current situation of the user. The check may be used to determine whether or not it is likely that the user may wish to capture a media item of the current situation.

For example, the predetermined threshold value may represent the time interval since a similar situation was captured by a media item. For instance, if the determined situation corresponds to a situation which has not been added to the plurality of media items associated with the user within a predetermined threshold time interval then, at block 55 the method comprises identifying a media item suggestion.

In some examples the predetermined threshold value may relate to the quality of the media item. For example, it may also be determined whether or not the user has a recent high quality photograph or audio recording of a situation and if the user does not have a recent high quality photograph or audio recording then at block 55 the apparatus 1 may identify an appropriate media item suggestion.

It is to be appreciated that the predetermined threshold value may relate to any suitable characteristics of the media items. For example it may provide an indication that an arrangement of objects and/or people in a current situation is different to arrangements of people and objects in stored media items.

The length of the predetermined threshold time interval may be dependent upon the media items which the user is taking or which are being uploaded and associated with a user. In some situations the time interval may be in the order of an hour. One example of such a situation could be that a user is at a party with a group of friends and takes lots of photographs of some friends but does not take very many pictures of other friends. In such circumstances it may be determined that a user has not taken a photograph of one particular friend for over an hour and the apparatus 1 may suggest that the user takes a photograph which includes that friend.

In some situations the recent time interval may be much larger, for example it may be of the order of weeks or months. For example a user might normally take lots of photographs or videos of their children. If they do not take any photographs or videos for a period of several weeks then, when the user is next with their children, the apparatus 1 may suggest that they take a photograph or a video which includes the children.

The media item suggestion may comprise an identification of people who may be included in the media item. For example it may include people who have not featured in a media item captured by the user of the apparatus 1 recently and/or people who have not been featured in a media item with the user of the apparatus 1 recently.

In some examples the media item suggestion may comprise a suggested combination of people. For instance, it may be determined that a first friend named Antti and a second friend named Jussi are near the user and have not been photographed together for several months. In such examples the photograph suggestion may be for Antti and Jussi to be photographed together.

In some examples the media item suggestion may be based on an activity which the user is performing. For example the one or more sensors 37 may comprise motion and/or location sensors which may be able to determine if a user is performing an activity such as walking or jogging. In such cases the comparison of the current situation and the information associated with the plurality of media items may determine that the user has not taken a photograph while out walking or jogging for a time period which is larger than a predetermined threshold value and may generate an appropriate media item suggestion such as taking a photograph.

In some examples the media item suggestion may be based on an activity which a person or people near the user is performing. For example, the sensors 37 may detect that a person is singing. It may be determined that the user does not have any recordings of this person or people singing or it may be determined that the user does not have any recordings of this person or people singing this particular song. In such cases a media item suggestion may be generated.

In some examples the media item suggestion may be based on the current weather in the location of the user. For instance it may be determined that all photographs or videos of the people around the user or at the user's current location have been captured in the rain but that the current weather is sunshine. A media item suggestion may be generated to suggest that a photograph or video of the people and/or location could be taken in the sunshine.

In some examples the media item suggestion may be based on the quality of the plurality of media items. For example it may be determined that all of the photographs of a particular person are blurry or have an otherwise poor image quality. The quality of the media item may be determined automatically, for example by using software based analysis of the pixels in a photograph. In some cases the quality of the media item may be determined based on comments or ratings given to the media item by the user of the apparatus 1 or the other users in the system 7. A media item suggestion may be generated when the user is near the particular person to suggest that a higher quality media item featuring the person is captured. In some examples the media item suggestion may also include a configuration for the image capture apparatus 33 such as focal length or shutter speed.

In some examples the media item suggestion may be based on the timings of the plurality of media items. For example the information associated with the plurality of media items may indicate that all media items of a particular person have been captured at a particular time of day. For instance it may be determined that all recent media items featuring the user's daughter have been captured in the morning. If it is determined that a user is with his daughter at a different time of day, such as the afternoon, then a media item suggestion may be generated to suggest that a media item is taken at that time.

In some examples the media item suggestion may be based on the location of the user of the apparatus 1. For example it may be determined that the user and one or more other people are in a location in which they have never been photographed or videoed. A media item suggestion may be generated to suggest that a photograph or video or other media item could be taken in this new location.

In some examples the media item suggestion may be based on objects which may be in the media items. For example it may be determined that all photographs of one friend, called John, have a dark background. It may be determined that the user is outside or in another bright location and is also with their friend John. A media item suggestion may be generated to suggest that John could be photographed with a different background.

In some examples the media item suggestion may also comprise suggested positions for the people in a photograph or video. For example, if one particular person is always positioned at the back of group photographs it may be suggested that they are positioned at the front to create a different photograph.

In some examples the media item suggestion may be based on activities which people are performing. For example, the system might determine based on metadata associated with previously captured media items such as videos that there are no videos of the user's friend dancing. If it is determined that the user and/or his friend is dancing then a media item suggestion may be generated to suggest that the user videos his friend dancing.

In some examples the media item suggestion might be to capture a video in a certain style. For example, the style could be in the style of a horror movie.

In another example the media item suggestion may be based on both the situation of the user and the situation of another user currently in the vicinity. For example, if the system observes that a user's friend is nearby and is currently singing, and that there are no recent videos where the user's friend would be singing, a media item suggestion to go and capture the friend singing may be created.

As a further example, the media item suggestion might be to record a voice of the user's child if there are no recent voice recordings of the child. As another example, the suggestion might comprise a suggestion to capture a voice recording of the user's child singing, if there are no recent voice recordings of the child singing.

As a further example, in some examples a suggestion to capture a different media type than what has been captured before may be created. For example, if the user only has photographs of friend John, a suggestion to capture video or audio of friend John may be created.

In some examples the media item suggestion may be based on current trends of media items. The current trends of media items may be determined from media items captured and/or stored by the user of the apparatus 1. In some examples the current trends of media items may be based on media items which have been shared by other users, for example using a social media network or other means for sharing media items.

In some examples it may be noted that there is a trend for two people to be photographed side by side. The media item suggestion may comprise the identities of people near the user of the apparatus 1 who could be photographed side by side.

In other examples it may be noted that there is a trend for photographs or videos with palm trees in the background as users of a social media network may be on holiday or have recently been on holiday. If the current situation of the user is determined to comprise a nearby palm tree then a media item suggestion may be generated suggesting that a photograph or video including the palm tree is taken.

In other examples it may be noted that there is a trend for certain effects to be applied to media items such as photographs. For example, there may be a trend for making the pictures black and white, or applying certain artistic filters on them. In this case, a suggestion may be created for the user to take a picture and apply a certain, trending, artistic filter or effect on it.

At block 56 the method comprises providing an indication of the media item suggestion to the user of the apparatus 1. The indication may be provided using the user interface 31. For example a message may be displayed on a display which may indicate a suggested situation for the media item.

In some examples the media item suggestion may comprises an image which represents the suggested layout of a photograph or video. For example images representing people could be displayed on a display to suggest a layout of a photograph or video.

The media item suggestion may comprise a suggestion of how the people and/or objects in the media item could be arranged. The arrangement could be based on a layout or background which is considered to be most aesthetically pleasing.

In some examples the media item suggestion may be provided as the user is preparing to capture a media item. For instance the user may be holding the user apparatus 1 ready to take a photograph of two people called Jussi and Antti. It may be determined that a third friend John is standing nearby and that John has not appeared in a recent photograph and/or a recent photograph with Jussi and Antti. In such examples the photograph suggestion may comprise using a wide angle mode so as to capture John in the photograph.

In some examples when the user is preparing to capture a media item information indicating the last time a similar photograph was taken may be indicated on the display. For example if a user is preparing to take a photograph of a group of people information indicating the last time each of those people was photographed may be displayed on the display.

Once the media item has been captured it may be automatically shared with other users featured in the media item. The user apparatus 1, 5 may automatically send the media item to the other user apparatus 1, 5 via the communication links 13 or via the communication link 11 to the one or more servers 3. In some examples the user apparatus 1, 5 may share the media items using social media applications. This may enable other users who are not in the current system 7 to access the media item.

In some examples the users may be able to add comments or rate the media item which has been captured. The ratings and comments may be added to the metadata associated with the media items.

FIG. 6 illustrates another example method. The example method of FIG. 6 may be implemented using one or more servers 3. The example method of FIG. 6 is similar to the method of FIG. 5 except that in FIG. 6 the analysis of the information may be performed by the server 3 rather than the user apparatus 1.

The method comprises, at block 61, storing a plurality of media items. The plurality of media items may be associated with a user of an image capturing apparatus. The plurality of media items may be stored in the memory circuitry 25 of the one or more servers 3. The plurality of media items may be as described above in relation to FIG. 5

At block 62 the method comprises obtaining information associated with the plurality of media items. The information may provide an indication of situations which are related to each of the plurality of media items. The information may be obtained by analysing metadata associated with the plurality of media items as described above. The analysis of the metadata may be carried out by the processing circuitry 23 of the user apparatus 1.

The method also comprises, at block 63, obtaining information indicating a situation of the user of the media capturing apparatus 1. In some examples the user apparatus 1, 5 may determine the current situation and then send information indicative of the determined situation to the one or more servers 5. For example, as described above, the one or more sensors 37, the image capture apparatus 33 and the audio capture apparatus 39 may be used to determine the current conditions of the user apparatus 1. In such examples obtaining the information indicating a situation of the user may comprise receiving the information at the server 3.

In other examples the server 3 may be configured to determine at least some of the information indicative of the user's current situation. For example, the user apparatus 1, 5 may be configured to send information indicative of their location to the server 3. The server 3 may then be able to determine when a plurality of user apparatus 1, 5 are near each other. In such examples the server 3 may send information to the user apparatus 1, 5 indicating that other user apparatus 1, 5 have been identified in the area.

At block 64 the method comprises comparing the determined situation with the situations indicated by the obtained information and at block 65 the method comprises checking whether the determined situation differs from the situation indicated by the obtained information by at least a predetermined threshold value. The comparison of the determined situation with the obtained information and the checking of the differences may be as described above in relation to FIG. 5.

At block 66 the method comprises identifying a media item suggestion if the determined situation exceeds a predetermined threshold value. The identifying a media item suggestion may be as described above in relation to FIG. 5.

At block 66 the method comprises enabling an indication of the media item suggestion to be provided to the user of the image capturing apparatus 1. The enabling of the media item suggestion to be provided to a user may comprise sending a message indicative of the media item suggestion to the user apparatus 1.

It is to be appreciated that in some examples the analysis of the information may be split between the user apparatus 1, 5 and the server 3. For example the server 3 may carry out an analysis of media items which have been obtained and may provide information indicative of this analysis to the user. This information may then be stored in the memory circuitry 25 of the user apparatus 1. The user apparatus may then be able to use this information to generate media item suggestions. This system may be useful, if for example the user has limited connection to the one or more servers. This may be the case if the user is on holiday and wishes to limit the amount of data they download to their user apparatus or if they are in a location which has poor network coverage.

The above described examples provide a system for capturing media items. The systems enables a media item suggestion to be provided to a user at appropriate times. This enables a user to capture more media items and may enable the user to take a higher quality of media items.

The examples provide timely reminders to user when they may wish to capture a media item. For example, if a user is in a social situation, they may often forget to take media item because they get involved in the social situation. The examples described above would prevent a user from missing an opportunity to capture media items which may be important to them.

The blocks illustrated in the FIGS. 5 to 6 may represent steps in a method and/or sections of code in the computer program. The illustration of a particular order to the blocks does not necessarily imply that there is a required or preferred order for the blocks and the order and arrangement of the block may be varied. Furthermore, it may be possible for some blocks to be omitted.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed. For example in the above described example the photograph suggestion is provided to the user of the apparatus 1. In other examples the media item suggestion may also indicate which user apparatus 1, 5 should be used to capture the media item. For example it may be determined which of the user apparatus 1, 5 in the system has the best camera. The user of this apparatus 1, 5 may receive a photo request message. The photograph request message may comprise an indication provided via the user interface 31. Once the user of the apparatus 1, 5 has taken the photograph the user may share the captured images with the other users.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
processing circuitry; and
memory circuitry including computer program code;
the memory circuitry and the computer program code configured to, with the processing circuitry, cause the apparatus at least to perform:
obtaining information associated with a plurality of media items wherein the plurality of media items are associated with a user of the apparatus and the information provides an indication of situations which relate to each of the plurality of media items;
determining a situation associated with the user of the apparatus;
comparing the determined situation with the situations indicated by the obtained information;
checking whether the determined situation differs from the situation indicated by the obtained information by at least a predetermined threshold value;
identifying a media item suggestion if the determined situation exceeds the predetermined threshold value; and
providing an indication of the media item suggestion to the user of the apparatus.

2. An apparatus as claimed in claim 1, wherein the information is obtained by analysing metadata associated with the plurality of media items wherein the metadata provides an indication of a situation which has been captured by the media items, wherein the memory circuitry and the computer program code configured to, with the processing circuitry, cause the apparatus to perform analysis of the metadata; the analysis of the metadata is performed by a remote server and the apparatus is configured to receive the information obtained from the analysis.

3. An apparatus as claimed in claim 1, wherein the plurality of media items comprises at least one of a) media items which have been captured by the user of the apparatus; b) media items which have been created by another user and which have metadata identifying the user of the apparatus associated with them; c) photographs, video, audio.

4. An apparatus as claimed in claim 1, wherein the situation of the user of the apparatus comprises one or more of, people near the user, activities of people near the user, a location of the user, a time of day, a date, a type of weather, objects surrounding the user.

5. An apparatus as claimed in claim 1 wherein the media item suggestion comprises an identification of people who could be included in the media item, suggested positions for the people in a photograph and suggested objects to be included in the media item.

6. An apparatus as claimed in claim 1, wherein the predetermined threshold comprises a time interval between capturing of media items associated with corresponding situations.

7. A method comprising:
obtaining information associated with a plurality of media items wherein the plurality of media items are associated with a user of a media capturing apparatus and the information provides an indication of situations related to each of the plurality of media items;
determining a situation associated with the user of the media capturing apparatus;
comparing the determined situation with the situations indicated by the obtained information;
checking whether the determined situation differs from the situation indicated by the obtained information by at least a predetermined threshold value;
identifying a media item suggestion if the determined situation exceeds the predetermined threshold value; and
providing an indication of the media item suggestion to the user of the media capturing apparatus.

8. A method as claimed in claim 7 wherein the information is obtained by analysing metadata associated with the plurality of media items wherein the metadata provides an indication of a situation which has been captured by the media items, wherein the analysis of the metadata is performed by at least one of the user's media capturing apparatus and a remote server and wherein the information obtained from the analysis is provided to the user's media capturing apparatus.

9. A method as claimed in claim 7 wherein the plurality of media items comprises at least one of a) media items which have been captured by the user of the apparatus, b) media items which have been created by another user and which have metadata identifying the user of the media capturing apparatus associated with them and c) media items comprises at least one of photographs, video, audio.

10. A method as claimed in claim 7 wherein the situation associated with the user of the media capturing apparatus comprises one or more of, people near the user, activities of people near the user, a location of the user, a time of day, a date, a type of weather, objects surrounding the user.

11. A method as claimed in any of claim 7 wherein the media item suggestion comprises at least one of a) an identification of people who could be included in the media item, b) the media item suggestion comprises suggested positions for the people in a photograph and c) the media item suggestion comprises suggested objects to be included in the media item.

12. A method as claimed in claim 7 wherein the predetermined threshold comprises a time interval between capturing of media items associated with corresponding situations.

13. A computer program comprising computer program instructions that, when executed by processing circuitry, enable:
obtaining information associated with a plurality of media items wherein the plurality of media items are associated with a user of a media capturing apparatus and the information provides an indication of situations related to each of the plurality of media items;
determining a situation associated with the user of the media capturing apparatus;
comparing the determined situation with the situations indicated by the obtained information;
checking whether the determined situation differs from the situation indicated by the obtained information by at least a predetermined threshold value;
identifying a media item suggestion if the determined situation exceeds the predetermined threshold value; and
providing an indication of the media item suggestion to the user of the media capturing apparatus.

14. An apparatus comprising:
processing circuitry; and
memory circuitry including computer program code;
the memory circuitry and the computer program code configured to, with the processing circuitry, cause the apparatus at least to perform:
storing a plurality of media items wherein the plurality of media items are associated with a user of a media capturing apparatus;
obtaining information associated with the plurality of media items wherein the information provides an indication of situations which are related to each of the plurality of media items;
obtaining information indicating a situation of the user of the media capturing apparatus;
comparing the determined situation with the situations indicated by the obtained information;
checking whether the determined situation differs from the situation indicated by the obtained information by at least a predetermined threshold value;
identifying a media item suggestion if the determined situation exceeds the threshold value; and
enabling an indication of the media item suggestion to be provided to the user of the media capturing apparatus.

15. An apparatus as claimed in claim 14 wherein the information associated with the plurality of media items is obtained by analysing metadata associated with the plurality of media items wherein the metadata provides an indication of a situation which has been captured by the media items.

16. An apparatus as claimed in claim 14 wherein the plurality of media items comprises media items which have been captured by the user of the media capturing apparatus and uploaded to a remote server, wherein the plurality of media items comprises media items which have been created by another user and which have metadata identifying the user of the media capturing apparatus associated with them.

17. A method comprising:
storing a plurality of media items wherein the plurality of media items are associated with a user of an media capturing apparatus;
obtaining information associated with the plurality of media items wherein the information provides an indication of situations which are related to each of the plurality of media items;
obtaining information indicating a situation of the user of the media capturing apparatus;
comparing the determined situation with the situations indicated by the obtained information;
checking whether the determined situation differs from the situation indicated by the obtained information by at least a predetermined threshold value;
identifying a media item suggestion if the determined situation exceeds the threshold value; and
enabling an indication of the media item suggestion to be provided to the user of the media capturing apparatus.

18. A method as claimed in claim 17 wherein the information associated with the plurality of media items is obtained by analysing metadata associated with the plurality of media items wherein the metadata provides an indication of a situation which has been captured by the media items.

19. A method as claimed in any of claim 17 wherein the plurality of media items comprises media items which have been captured by the user of the media capturing apparatus and uploaded to a remote server, wherein the plurality of media items comprises media items which have been created by another user and which have metadata identifying the user of the image capturing apparatus associated with them.

20. A computer program comprising computer program instructions that, when executed by processing circuitry, enable:
storing a plurality of media items wherein the plurality of media items are associated with a user of a media capturing apparatus;
obtaining information associated with the plurality of media items wherein the information provides an indication of situations which are related to each of the plurality of media items;
obtaining information indicating a situation of the user of the media capturing apparatus;
comparing the determined situation with the situations indicated by the obtained information;
checking whether the determined situation differs from the situation indicated by the obtained information by at least a predetermined threshold value;
identifying a media item suggestion if the determined situation exceeds the threshold value; and
enabling an indication of the media item suggestion to be provided to the user of the media capturing apparatus.
